(19) United States
(12) Patent Application Publication
(10) Pub. No.: US 2009/0175531 A1
(43) Pub. Date: Jul. 9, 2009

(54) SYSTEM AND METHOD FOR FALSE POSITIVE REDUCTION IN COMPUTER-AIDED DETECTION (CAD) USING A SUPPORT VECTOR MACNINE (SVM)

(75) Inventors: Lilla Boroczky, Mount Kisco, NY (US); Luyin Zhao, White Plains, NY (US); Kwok Pun Lee, Flushing, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/719,659

(22) PCT Filed: Nov. 18, 2005
(86) PCT No.: PCT/IB05/53824

§ 371 Date: May 18, 2007

Related U.S. Application Data
(60) Provisional application No. 60/629,751, filed on Nov. 19, 2004.
(60) Provisional application No. 60/722,668, filed on Sep. 30, 2005.

(51) Int. Cl. G06K 9/62

(52) U.S. Cl. 382/159

(57) ABSTRACT

A method for computer aided detection (CAD) and classification of regions of interest detected within HRCT medical image data includes post-processing machine learning to maximize specificity and sensitivity of the classification to realize a reduction in number of false positive detections reported. The method includes training a classifier on a set of medical image training data selected to include a number of true and false regions, wherein the true and false regions are identified by a CAD process, and automatically segmented, wherein the segmented training regions are reviewed by at least one specialist to classify each training region for its ground truth, i.e., true or false, essentially qualifying the automatic segmentation, wherein a feature pool is identified and extracted from each segmented region, and wherein the pool of features is processed by genetic algorithm to identify an optimal feature subset, which subset is used to train a support vector machine, detecting, within non-training medical image data, regions that are candidates for classification, segmenting the candidate regions, extracting a set of features from each segmented candidate regions and classifying the candidate region using the support vector machine after training in accordance with the optimal feature subset, and processing the set of candidate features.

This application/patent derives from U.S. Provisional Patent Application No. 60/629, 751, filed Nov. 19, 2004, by the named applicants. The application is related to commonly-owned co-pending Philips applications number PHUS040499, PHUS040500 and PHUS040501.

The present inventions relate to computer-aided detection systems and methods. The inventions relate more closely to systems and methods for false positive reduction in computer-aided detection (CAD) of lung nodules, from high-resolution, thin-slice computed tomographic (HRCT) images, using support vector machines (SVMs) to implement post-CAD machine learning.

The speed and sophistication of current computer-related systems support development of faster, and more sophisticated medical imaging systems. The consequential increase in amounts of data generated for processing, and processing, has led to the creation of numerous application programs to automatically analyze the medical image data. That is, various data processing software and systems have developed in order to assist physicians, clinicians, radiologists, etc., in evaluating medical images to identify and/or diagnose and evaluate medical images. For example, computer-aided detection (CAD) algorithms and systems have developed to automatically identify suspicious lesions from multi-slice CT (MSCT) scans. CT, or computed tomographic systems, are imaging modalities that are commonly used to diagnose disease through imaging, in view of its ability to precisely illustrate size, shape and location of anatomical structures, as well as abnormalities or lesions.

CAD systems automatically detect (identify) morphologically interesting regions (e.g., lesions), or other structurally detectable conditions, which might be of clinical relevance. When the medical image is rendered and displayed, the CAD system typically marks or identifies the investigated region. The marks are to draw attention to the suspected region as marked, and may further provide a classification or characterization of the lesion (region of interest). That is, a CAD (and/or CADx) system may identify microcalcifications in breast study, or nodules in MSCT, as malignant or benign. CAD systems incorporate the expert knowledge of radiologists, and essentially provide a second opinion regarding detection of abnormalities in medical image data, and may render diagnostic suggestions. By supporting the early detection and classification of lesions suspicious for cancer, CAD systems allow for earlier interventions, theoretically leading to better prognosis for patients.

Most existing work for CAD and other machine learning systems follow the same methodology for supervised learning. The CAD system starts with a collection of data with a known ground truth, and is “trained” on the training data to identify a set of features believed to have enough discriminant power to distinguish the ground truth, for example, malignant or benign. Challenges for those skilled in the art include extracting the features that facilitate discrimination between categories, ideally finding the most relevant features within a feature pool. CAD systems may combine heterogeneous information (e.g. image-based features with patient data), or they may find similarity metrics for example-based approaches. The skilled artisan understands that the accuracy of any computer-driven decision-support system is limited by availability of the set of patterns already classified to the learning process (i.e., by the training set).

If an indefinite boundary is the basis for post-CAD processing, the results based on an indefinite boundary delineation may be indefinite as well. That is, the output of any computer-learning system used in diagnostic scanning processes is advice. So with each advice presented to the clinician as a possible candidate malignancy, the clinician is compelled to investigate. That is, where a CAD assisted outcome represents a bottom line truth (e.g., true positive) as a suggested diagnosis for a region investigated, the clinician would be negligent were he/she to NOT investigate the region more particularly. Those skilled in the art should understand that in the medical context, “true positive” often refers to a detected nodule that is truly malignant, in a CAD context, a marker is considered to be a true positive marker even it points at a benign or calcified nodule. It follows that “true negative” is not defined and a normalized specificity cannot be given in CAD. False positive markings are those which do not point at nodules at all (but at scars, bronchial wall thickenings, motion artifacts, vessel bifurcations, etc). Accordingly, CAD performance is typically qualified by sensitivity (detection rate) and false positive rate (false positive markings per CT study), and as such, quite desirable to the skilled artisan to minimize false positives.

After completion of the automated detection processes (with or without marking), most CAD systems automatically invoke one or more interception tools for application of user- and CAD-detected lesions (regions), eliminating redundancies, implementing interpretive tools, etc. To that end, various techniques are known for reducing false positives in CAD and diagnoses. For example, W. A. H. Mousa and M. A. U. Khan, disclose their technique entitled: “Lung Nodule Classification Utilizing Support Vector Machines,” Proc. of IEEE ICIP'2002. K. Suzuki, S. G. Armato III, F. Li, S. Sone, K. Doi, describe an attempt to minimize false positive detection in: “Massive training artificial neural network (MTANN) for reduction of false positives in computerized detection of lung nodules in low-dose computed tomography”, Med. Physics 30(7), July 2003, pp. 1602-1617, as well as Z. Ge, B. Sahiner, H.-P. Chan, L. M. Hadjiski, J. Wei, N. Bogot, P. N. Cascade, E. A. Kazerooni, C. Zhou, “Computer aided detection of lung nodules: false positive reduction using a 3D gradient field method”, Medical Imaging 2004: Image Processing, pp. 1076-1082.

Some of the above-mentioned FPR systems are embedded in a CAD algorithm, while others are used as a post-processing step to improve the specificity of a CAD algorithm. For example, R. Wiemker, et al., in their COMPUTER-AIDED SEGMENTATION OF PULMONARY NODULES: AUTOMATED VASCULATURE CUTOFF IN THIN- AND THICK-SLICE CT, 2003 Elsevier Science BV, discuss maximizing sensitivity of a CAD algorithm to effectively separate lung nodules from the nodule's surrounding vasculature in thin-slice CT (to remedy the partial volume effect), and in an effort to reduce classification errors. However, the Weimker FPR systems and methods, like most known FPR systems and methods, often fail to use sophisticated machine learning techniques, or their feature extraction and selection methods are not optimized. For example, while Mousa, et al. utilize support vector machines to distinguish true lung nodules from non-nodules (FPs), their system is based on a very simplistic feature extraction unit which can limit specificity.

It is therefore the object of this invention to provide a false positive reduction system that accurately and reliably performs automatic detection of a radiologically significant portions of medical image data, and classifying same in such a way as to realize very good specificity and sensitivity (i.e., minimal false positives).

It is another object of the invention to realize a FPR system that includes a CAD sub-system for identifying and delineating morphologically relevant regions (“candidate regions”) within a medical image, and a machine-learning sub-system, which includes a feature extractor, genetic algorithm (GA) and support vector machine (SVM), to apply machine learning to candidate regions delineated by the CAD sub-system and classify them as nodules and non-nodules, thereby eliminating as many false positives as possible under the constraint that all true positives are retained.

It is yet another object of the invention to include post-CAD machine learning techniques for detecting, extracting and classifying candidate nodules from medical image data with sufficient specificity and sensitivity to virtually eliminate false positive classification. The candidate nodules are first identified by a CAD process, the nodule features extracted and processed by a GA to identify the ideal features and numbers of feature for use by a classifier process, which identifies all nodules as malignant or benign with sufficient sensitivity and specificity to effectively reduce the number of falsely identified nodules, supported by the machine learning of the post-CAD determined sub-set of features.

In one embodiment, a method for false positive reduction (FPR), is implemented as a sequence of four main steps: 1) image segmentation (by CAD), 2) feature extraction from the segmented data, 3) feature sub-set optimization by GA, post-CAD, and 4) classification by a SVM based on the optimized feature sub-set, resulting in reliable sensitivity and specificity, and minimal false positives. For that matter, an inventive FPR system as defined herein may comprise a CAD sub-system. If so, the sub-system may include a novel segmenter with a recommender sub-system to identify the “best” segmentation of a region under analysis. Such a variation on the present invention may be found, and claimed in commonly-owned, co-pending [US application serial number 10/______] Philips application number US040505, filed concurrently herewith.

While the inventive systems and methods are described as operating on CT, or high-resolution CT scan data (HRCT), those skilled in the art understand that the descriptions are not meant to limit the scope of the inventions to operation on CT or HRCT data, but may operate on any acquired imaging data, limited only by the scope of the claims attached hereto.

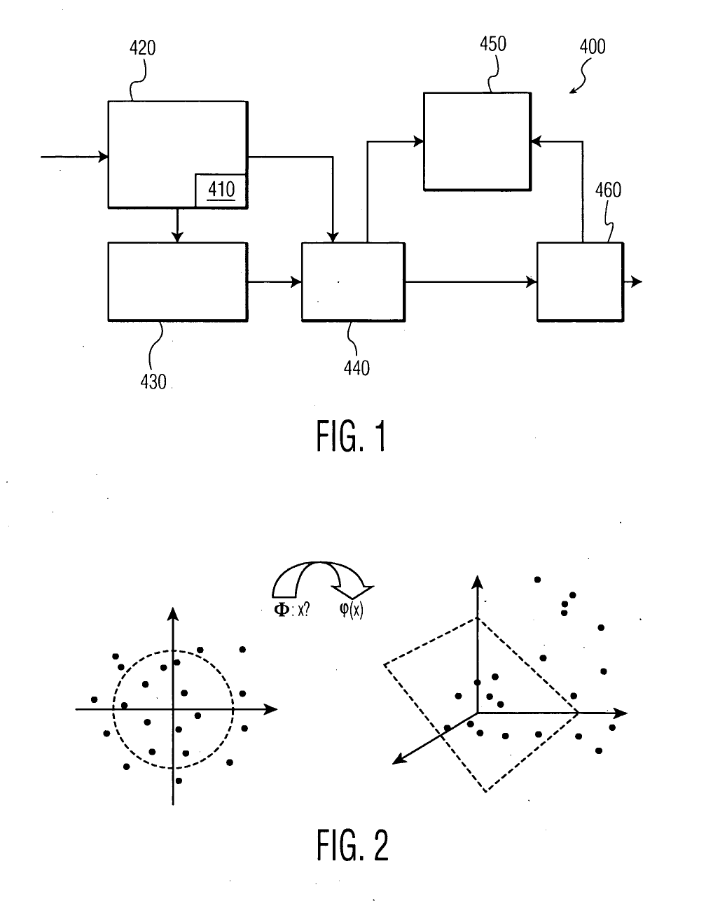

FIG. 1 is a diagram depicting a system for false positive reduction (FPR) in computer-aided detection (CAD) from Computed Tomography (CT) medical images using support vector machines (SVMs);

FIG. 2 is a diagram depicting a basic idea of a support vector machine; and

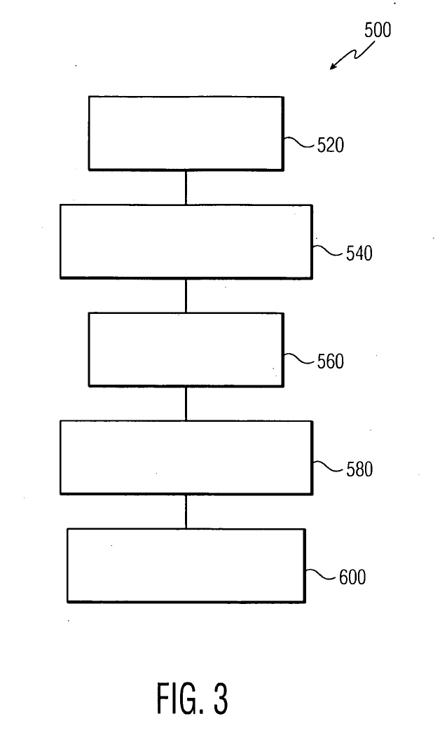

FIG. 3 is a process flow diagram identifying an exemplary process of the inventions.

The underlying goal of computer assistance (CAD and CADx) in detecting lung nodules in image data sets (e.g., CT) is not to designate the diagnosis to a machine, but rather to realize a machine-based algorithm or method to support the radiologist in rendering his/her decision, i.e., pointing to locations of suspicious objects so that the overall sensitivity (detection rate) is raised. The principal problem with CAD or other clinical decision support systems is that inevitably false markers (so called false positives) come with the true positive marks. Experience with clinical studies has shown that the measured detection rates achieved by CAD systems as well as by radiologists themselves clearly depend on the number of co-reading radiologists: the more co-readers participate, the more suspicious lesions will inevitably be found, and thus the individual sensitivity of each participating radiologist and CAD system will decrease. But even though the absolute sensitivity figures have to be appreciated with care, all clinical studies have agreed in that a significant number of nodules have been detected by the additional CAD software alone, while being overlooked by all co-reading radiologists. The present inventions provide for such sensitivity.

CAD-based systems that include false positive reduction processes, such as those described by Wiemker, Mousa, et al., etc., have one big job and that is to identify “actionable” structures detected in medial image data. Once identified (i.e., segmented), a comprehensive set of significant features is obtained by the CAD system in order to classify the segmented region as to some ground truth, e.g., malignant or benign. Those skilled in the art will recognize that the accuracy of computer driven decision support, or CAD systems, is limited by availability of a set of patterns or regions of known pathology used as the training set. Even state-of-the-art CAD algorithms, such as described by Wiemker, R., T. Blaffert, in their: Options to improve the performance of the computer aided detection of lung nodules in thin-slice CT. 2003, Philips Research Laboratories: Hamburg, and by Wiemker, R., T. Blaffert, in their: Computer Aided Tumor Volumetry in CT Data, Invention disclosure. 2002, Philips Research, Hamburg, can result in high numbers of false positives, leading to unnecessary interventions with associated risks and low user acceptance. Moreover, current false positive reduction algorithms often were developed for chest radiograph images or thick slice CT scans, and do not necessarily perform well on data originated from HRCT.

To that end, the inventive FPR systems and methods described herein include a CAD sub-system or process to identify candidate regions, which are segmented. During training, and after the CAD process, the segmented regions within the set of training data are passed to a feature extractor, or a processor implementing a feature extraction process. Feature extraction obtains 3D and 2D features from the detected structures, which are passed to a genetic algorithm (GA) sub-system, or GA processor. At least one clinician skilled in the art of detecting relevant regions in medical images is required to support training. The GA processor processes the extracted feature sets (from the training images) to realize an optimal feature subset. An optimal feature subset includes an optimal number of the optimal features that provides sufficient discriminatory power for the SVM, with FPR.

During training, the post-CAD processing by the GA determines an optimal sub-set of features for use by a machine learning process. The SVM uses the feature subset for its machine learning. Thereafter, images under investigation are processed by the CAD sub-system, with or without a segmenter, to identify and segment the candidate regions. The set of features extracted from the candidate regions are operated on by the trained classifier (SVM). Because of the unique post-CAD machine learning, the inventive FPR system accurately, and with sufficient specificity and sensitivity, detects small lung nodules in high resolution and thin slice CT (HRCT) images. Those skilled in the art will understand that the inventive FPR system may accurately detect and classify nodules or microcalcifications that were invisible using inferior techniques. For example, HRCT data with slice thickness <=1 mm allows detection of very small nodules, but to do so requires new approaches for reliable detection, and discrimination from vessels, such as the inventions set forth herein.

A preferred embodiment of an FPR system 400 of the invention will be described broadly with reference to FIG. 1. FPR system 400 (with false positive reduction) includes a CAD sub-system 420, for identifying and segmenting regions meeting particular criteria. Preferably, the CAD sub-system includes a CAD processor 410, and may further include a segmenting unit 430 to perform low level processing on medical image data. The CAD sub-system 420 segments candidate nodules (regions of interest), identified by the CAD process, whether operating upon training data or investigating a candidate region. The CAD sub-system guides the parameter adjustment process to realize a stable segmentation.

The segment data are output to a feature extraction unit 440 comprising the FPR sub-system. A pool of features is extracted from each segmented region, training or candidate, and operated upon by the Genetic Algorithm processor 450 in order to identify a “best” set sub-set of features to train the SVM. That is, GA processor 450 generates an optimized subset of features, with respect to both the choice of and number of features included from the feature pool. The subset is used by a support vector machine (SVM) 460 to classify with sufficient good sensitivity and specificity that minimal false positives are identified (in error) when operating on a set of features extracted from a candidate region. That is, when investigating a candidate region, as distinguished from training, the features extracted are forwarded to the SVM for classification.

As mentioned above, CAD sub-system 420, whether it comprises segmenting unit 430, or not, delineates the candidate nodules (including non-nodules) from the background by generating a binary or trinary image, where nodule-, background- and lung-wall (or “cut-out”) regions are labeled. Upon receipt of the gray-level and labeled VOI, the feature extractor calculates (extracts) any relevant features, such as 2D and 3D shape features, histogram-based features, etc. In training mode, feature extraction is crucial, as it greatly influences the overall performance of the FPR system. Without proper extraction of the entire set or pool of features, the GA cannot determine the feature subsets with the best discriminatory power and the smallest size (in order to avoid over-fitting and increase generalizability).

A GA-based feature selection process is taught by commonly owned, co-pending [U.S. patent application Ser. No.] Philips application number US040120 (ID disclosure # 779446), the contents of which are incorporated by reference herein. The GA's feature subset selection is initiated by creating a number of “chromosomes” that consist of multiple “genes”. Each gene represents a selected feature. The set of features represented by a chromosome is used to train an SVM on the training data. The fitness of the chromosome is evaluated by how well the resulting SVM performs. At the start of this process, a population of chromosomes is generated by randomly selecting features to form the chromosomes. The algorithm (i.e., the GA) then iteratively searches for those chromosomes that perform well (high fitness).

At each generation, the GA evaluates the fitness of each chromosome in the population and, through two main evolutionary methods, mutation and crossover, creates new chromosomes from the current ones. Genes that are in “good” chromosomes are more likely to be retained for the next generation and those with poor performance are more likely to be discarded. Eventually an optimal solution (i.e., a collection of features) is found through this process of survival of the fittest. And by knowing the best feature subset, including the best number of features to realize false positive reduction (FPR) that reduces the total number of misclassified cases. After the feature subset is determined, the sub-set is used to train the SVM. Those skilled in the art should understand that SVMs map “original” feature space to some higher-dimensional feature space, where the training set is separable by a hyperplane, as shown in FIG. 2. The SVM-based classifier has several internal parameters, which may affect its performance. Such parameters are optimized empirically to achieve the best possible overall accuracy. Moreover, the feature values are normalized before being used by the SVM to avoid domination of features with large numeric ranges over those having smaller numeric ranges, which is the focus of the inventive system and processes taught by commonly-owned, co-pending [U.S. patent application Ser. No. 10/] Philips application No. US 040499 (ID disclosure no. 778965). Normalized feature values also render calculations simpler. And because kernel values usually depend on the inner products of feature vectors, large attribute values might cause numerical problems. The scaling for the range of [0,1] was done as

x′=(x−mi)/(Mi−mi),

where,
x′ is the “scaled” value;
x is the original value;
Mi is the maximum value in the array; and
mi is the minimum value in the array.

The inventive FPR system was validated using a lung nodule dataset that had included training data or regions whose pathology is known, utilizing what may be referred to as a “leave-one-out and k-fold validation”. The validation was implemented and the inventive FPR system was shown to reduce the majority of false nodules while virtually retaining all true nodules. It is the CAD sub-system, which may or may not include a segmenter (as shown in FIG. 1), delineates nodules and non-nodules from the background by generating a binary or trinary image, whereby nodule-, background- and lung-wall or (“cut-out”) regions are labeled. Using the gray-level and label VOI, the machine-learning subsystem, with feature extraction unit, calculates different features, such as 2D and 3D shape features, histogram-based features, etc.

FIG. 3 is a flow diagram depicting a process, which may be implemented in accordance with the present invention. That is, FIG. 3 is a flow diagram setting forth one embodiment of on applied process of the inventions herein. Box 550 represents training a classifier on a set of medical image training data for which a clinical ground truth about the regions is known. In one embodiment, the step may include training a classifier on a set of medical image training data selected to include a number of true and false regions, wherein the true and false regions are identified by a CAD process, and automatically segmented, wherein the segmented training regions are reviewed by at least one specialist to classify each training region for its ground truth, i.e., true or false, wherein a feature pool is identified and extracted from each segmented region, and wherein the pool of features is processed by genetic algorithm to identify an optimal feature subset, which subset is used to train a support vector machine.

Box 540 represents a step of detecting, within non-training medical image data, regions that are candidates for classification, and Box 560 represents the step of segmenting the candidate regions. Box 580 represents a step of further processing the segmented regions to extract a full feature set (pool) relating to each region of interest. Box 600 represents a step of operating upon the full feature set of each known training region with a genetic algorithm to identify an optimal sub-set of features, to train a support vector machine. After training, the SVM operates on the set of features extracted from a candidate region. The step of training may include using a recommender in the segmentation process, which recommender offers a trainer actual choices for best segmentation of a region with a known pathology.

It is significant to note that software required to perform the inventive methods, or which drives the inventive FPR classifier, may comprise an ordered listing of executable instructions for implementing logical functions. As such, the software can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments of the present invention, particularly, any “preferred” embodiment(s), are merely possible examples of implementations that are merely set forth for a clear understanding of the principles of the invention. Furthermore, many variations and modifications may be made to the above-described embodiments of the invention without departing substantially from the spirit and principles of the invention. All such modifications and variations are intended to be taught by the present disclosure, included within the scope of the present invention, and protected by the following claims.

What is claimed is:

1. A method for false positive reduction (FPR) during computer aided detection (CAD) and classification of regions within medical image data, such as HRCT data, which method implements post-processing machine learning to maximize specificity and sensitivity of classification, and realize a reduction in the number of false positive detections reported by the FPR system, the method comprising the steps of:
training a classifier on a set of medical image training data selected to include a number of true and false regions, wherein the true and false regions are identified by a CAD process, and automatically segmented, wherein the segmented training regions are reviewed by at least one specialist to classify each training region for its ground truth, i.e., true or false, essentially qualifying the automatic segmentation, wherein a feature pool is identified and extracted from each segmented region, and wherein the pool of features is processed by genetic algorithm to identify an optimal feature subset, which subset is used to train a support vector machine;
detecting, within non-training medical image data, regions that are candidates for classification;
segmenting the candidate regions;
extracting a set of features from each segmented candidate regions; and
classifying the candidate region using the support vector machine after training in accordance with the optimal feature subset, and processing the set of candidate features.

2. The process for CAD and classification as set forth in claim 1, wherein the step of training further includes determining both the size of the feature subset providing the best fit, and the identity of the features.

3. The process for CAD and classification as set forth in claim 2, wherein the determining includes applying the GA in two phases, including:
a.) identifying each chromosome as to both its set of features, and the number of features; and
b.) analyzing, for each chromosome, the identified set of features, and the identified number of features, to determine the optimal size of the feature based on the number of occurrences of different chromosomes and a number of average errors.

4. The process for CAD and classification as set forth in claim 1, wherein the step of training further includes defining a pool of features as a chromosome, where each feature represents gene, and where the genetic algorithm initially populates the chromosomes by random selection of features, and iteratively searches for those chromosomes that have higher fitness, wherein the evaluation is repeated for each generation, and using mutation and crossover, generate new and more fit chromosomes.

5. A computer readable medium comprising a set of computer readable instructions, which by processing by a general purpose computer downloaded with the instructions, implements a method comprising the steps of:
A method for false positive reduction (FPR) during computer aided detection (CAD) and classification of regions within medical image data, such as HRCT data, which method implements post-processing machine learning to maximize specificity and sensitivity of classification, and realize a reduction in the number of false positive detections reported by the FPR system, the method comprising the steps of:
training a classifier on a set of medical image training data selected to include a number of true and false regions, wherein the true and false regions are identified by a CAD process, and automatically segmented, wherein the segmented training regions are reviewed by at least one specialist to classify each training region for its ground truth, i.e., true or false, essentially qualifying the automatic segmentation, wherein a feature pool is identified and extracted from each segmented region, and wherein the pool of features is processed by genetic algorithm to identify an optimal feature subset, which subset is used to train a support vector machine;
detecting, within non-training medical image data, regions that are candidates for classification;
segmenting the candidate regions;
extracting a set of features from each segmented candidate regions; and
classifying the candidate region using the support vector machine after training in accordance with the optimal feature subset, and processing the set of candidate features.

6. A medical image classification system that includes CAD sub-system and sub-system for false positive reduction (FPR), which FPR sub-system comprises a support vector machine trained post-CAD, classifies clinically relevant regions detected within imaging data with specificity and sensitivity to minimize false positives reported, comprising:
a CAD sub-system for identifying and delineating clinically relevant regions detected within the image data;
a false positive reduction sub-system in communication with the CAD sub-system, comprising:
a feature extractor for extracting a pool of features from each CAD-delineated region;
a genetic algorithm in communication with the feature extractor to provide an optimal subset of the feature pool; and
a support vector machine (SVM) in communication with the feature extractor and GA, which classifies each delineated region in accord with the feature subset with a minimum of false positives;
wherein the system is first trained on a set of images that include regions which are known to be either true or false positives, extracting features therefrom and using the GA to identify an optimal subset such that the SVM optimally classifies unknown regions.

7. The medical image classification system set forth in claim 6, where the CAD subsystem further includes a segmenting sub-system for delineating regions identified by the CAD sub-system.
